(19) United States
(12) Patent Application Publication
(10) Pub. No.: US 2010/0242946 A1
(43) Pub. Date: Sep. 30, 2010

(54) Steam Case Having An Energy-Saving Function

(76) Inventor: Hui-Hsiung Su, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/414,919

(22) Filed: Mar. 31, 2009

(51) Int. Cl. A47J 27/04

(52) U.S. Cl. 126/369

(57) ABSTRACT

A steam case includes a case body having an inner portion provided with a receiving chamber which has a bottom provided with a water tank. The case body has a lower portion provided with a receiving space located under the water tank to receive a burner. The case body is provided with an inner water storage conduit, an outer water storage conduit and an air draining channel located between the inner water storage conduit and the outer water storage conduit. Thus, the waste air produced by the burner during the heating process is kept at a higher temperature and can be reused to heat the water in the inner water storage conduit and the outer water storage conduit and to increase the temperature of the water in the water tank so as to shorten the heating time of the steam case.

### BACKGROUND OF THE INVENTION

1. Field of the Invention

The present invention relates to a case and, more particularly, to a steam case that produces steams to steam or braise a food.

2. Description of the Related Art

A conventional steam case comprises a case body containing water therein and a burner (such as a gas stove and the like) located under the case body to heat the water contained in the case body. The case body has an inner portion provided with a hollow receiving chamber to receive the water and has a top wall having a surface provided with a plurality of steam outlet holes each connected to the receiving chamber. When in use, multiple steamers (or steam baskets) are placed on the top of the case body and are located above the steam outlet holes of the case body. Then, the water in the receiving chamber of the case body is heated and vaporized by the burner to produce steams which rise in the receiving chamber of the case body and are drained outwardly from the steam outlet holes of the case body so as to steam or braise foods placed in the multiple steamers. However, the conventional steam case has a lower heating efficiency, thereby wasting the thermal energy and thereby increasing the heating time. In addition, the waste air produced by the burner during the heating process is directly drained outwardly and is not reused or recycled, thereby wasting the energy.

### BRIEF SUMMARY OF THE INVENTION

In accordance with the present invention, there is provided a steam case, comprising a case body having an inner portion provided with a hollow receiving chamber. The receiving chamber of the case body has a bottom provided with a water tank connected to the receiving chamber. The case body has a lower portion provided with a receiving space located under the water tank to receive a burner. The case body is provided with an inner water storage conduit and an outer water storage conduit. The case body is provided with an air draining channel located between the inner water storage conduit and the outer water storage conduit.

The primary objective of the present invention is to provide a steam case having an energy-saving function.

Another objective of the present invention is to provide a steam case, wherein the waste air produced by the burner during the heating process is kept at a higher temperature and can be reused to heat the water in the inner water storage conduit and the outer water storage conduit and to increase the temperature of the water in the water tank of the case body so as to shorten the heating time of the steam case.

A further objective of the present invention is to provide a steam case, wherein the waste air produced by the burner during the heating process can be recycled and reused to provide a thermal energy to the steam case so as to save the energy resource.

A further objective of the present invention is to provide a steam case, wherein the water storage channel extends downward from the water tank so that the heat produced by the burner will not escape from the two sidewalls or the front wall of the case body so as to enhance the heating area and efficiency of the steam case.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a steam case in accordance with the preferred embodiment of the present invention.

FIG. 2 is a perspective view showing opening of the steam case as shown in FIG. 1.

FIG. 3 is a cross-sectional view of the steam case taken along line 3-3 as shown in FIG. 2.

FIG. 4 is a cross-sectional view of the steam case taken along line 4-4 as shown in FIG. 3.

FIG. 5 is a cross-sectional view of the steam case taken along line 5-5 as shown in FIG. 4.

FIG. 6 is a schematic operational view of the steam case as shown in FIG. 4 in use.

### DETAILED DESCRIPTION OF THE INVENTION

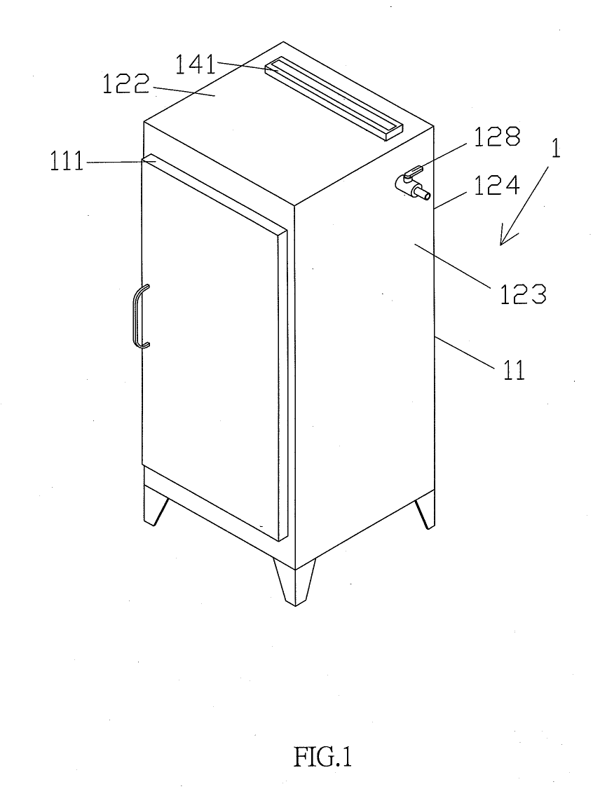

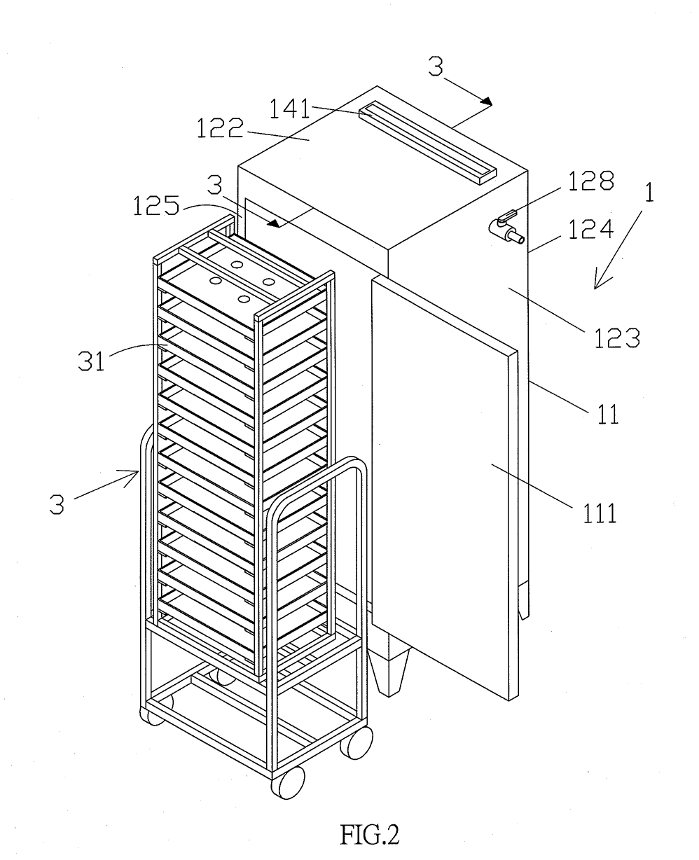

Referring to the drawings and initially to FIGS. 1-5, a steam case 1 in accordance with the preferred embodiment of the present invention comprises a case body 11 to receive a plurality of steam trays (or baskets) 31 and a door 111 pivotally mounted on the case body 11 to open or close the case body 11. The steam trays 31 are carried by a cart 33.

The case body 11 has a front wall 125, a rear wall 124, a top wall 122, a bottom wall 121 and two opposite sidewalls 123. The case body 11 has a peripheral wall provided with a warming layer 17 to prevent a heat loss of the case body 11. The case body 11 is provided with a water inlet hole 129 for mounting a water inlet valve 128 and at least one water outlet hole 127 for mounting at least one water outlet valve 1280. The water inlet hole 129 and the at least one water outlet hole 127 of the case body 11 are located on one of the two sidewalls 123 of the case body 11. The door 111 is pivotally mounted on the front wall 125 of the case body 11.

The case body 11 has an inner portion provided with a hollow receiving chamber 12. The receiving chamber 12 of the case body 11 has a peripheral wall made of a metallic sheet plate. The receiving chamber 12 of the case body 11 has a bottom provided with a water tank 13 connected to the receiving chamber 12 to receive water 4. The case body 11 has a lower portion provided with a receiving space 21 located under the water tank 13 to receive a burner 2, such as a gas stove and the like. The case body 11 is provided with an air draining channel 14 located between the receiving chamber 12 and the rear wall 124 of the case body 11. The air draining channel 14 of the case body 11 has a top provided with an elongate air draining port 141 exposed outwardly from the top wall 122 of the case body 11. The air draining channel 14 of the case body 11 has a bottom connected to the receiving space 21.

Thus, when the water 4 in the water tank 13 is heated by the burner 2, the waste air produced by the burner 2 during the heating process passes through the air draining channel 14 of the case body 11 and is drained outwardly from the air draining port 141 of the air draining channel 14. After the water 4 in the water tank 13 is vaporized to produce steams, the steams will rise and circulate in the receiving chamber 12 of the case body 11. Preferably, the bottom of the air draining channel 14 is provided with a guide ramp 142 facing the burner 2 to facilitate drainage of the waste air produced by the burner 2.

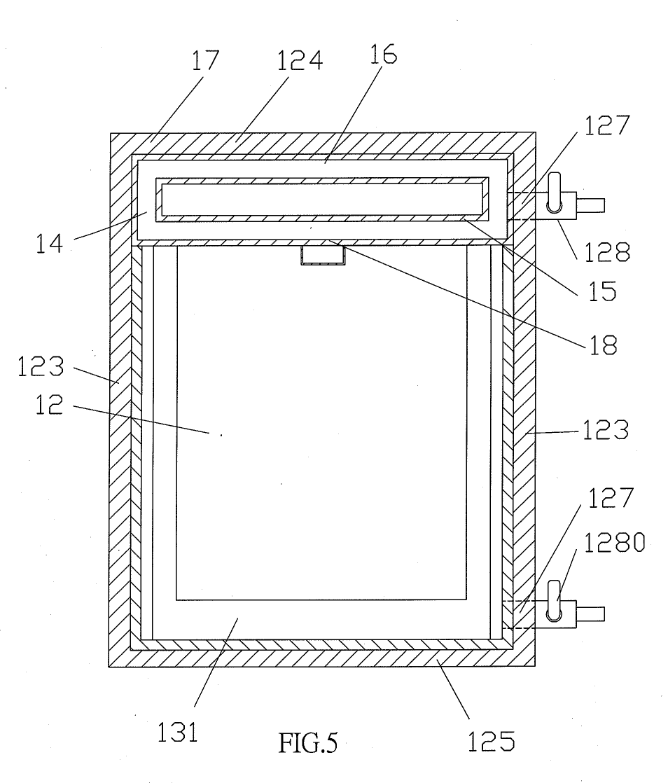

The case body 11 is further provided with an inner water storage conduit 15 and an outer water storage conduit 16 each filled with water and each located between the receiving chamber 12 and the rear wall 124 of the case body 11. The air draining channel 14 of the case body 11 is located between the inner water storage conduit 15 and the outer water storage conduit 16. The inner water storage conduit 15 and the outer water storage conduit 16 of the case body 11 form a loop as shown in FIG. 5 to encompass the air draining channel 14 completely.

Thus, when the waste air produced by the burner 2 during the heating process passes through the air draining channel 14 of the case body 11, the waste air at a higher temperature can be used to heat the water in the inner water storage conduit 15 and the outer water storage conduit 16 of the case body 11.

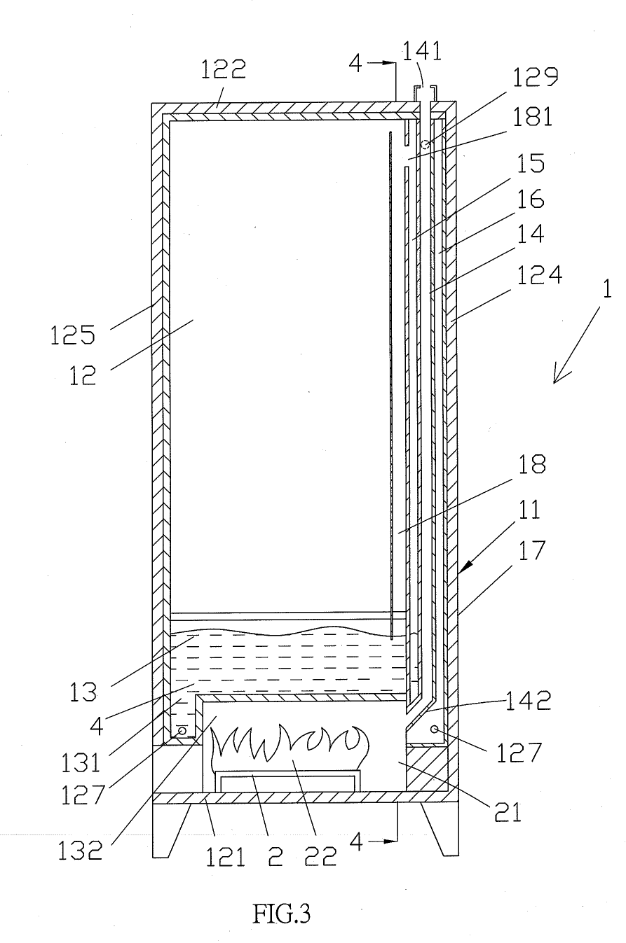

In the preferred embodiment of the present invention, the outer water storage conduit 16 of the case body 11 is connected to the water inlet hole 129 of the case body 11 as shown in FIG. 3, and the inner water storage conduit 15 of the case body 11 is connected to the outer water storage conduit 16 as shown in FIG. 5, so that the water is introduced from the water inlet hole 129 of the case body 11 into the outer water storage conduit 16 and the inner water storage conduit 15. The case body 11 is further provided with a passage 18 located and connected between the receiving chamber 12 and the inner water storage conduit 15. The passage 18 of the case body 11 has a bottom connected to the water tank 13 and has a top provided with an overflow hole 181 connected to a top of the inner water storage conduit 15.

Thus, when the water level in the inner water storage conduit 15 of the case body 11 reaches the height of the overflow hole 181 of the passage 18, the overflow water in the inner water storage conduit 15 and the outer water storage conduit 16 of the case body 11 is introduced through the overflow hole 181 and the passage 18 into the water tank 13 of the case body 11. The water tank 13 of the case body 11 is provided with a control switch (not shown) to control the water level in the water tank 13 of the case body 11.

The water tank 13 has a bottom provided with a receiving recess 132 located above the burner 2. The receiving recess 132 of the water tank 13 is located above and connected to the receiving space 21 of the case body 11 to receive the burner 2. The bottom of the air draining channel 14 of the case body 11 is connected to the receiving recess 132 of the water tank 13. The guide ramp 142 of the air draining channel 14 faces the receiving recess 132 of the water tank 13.

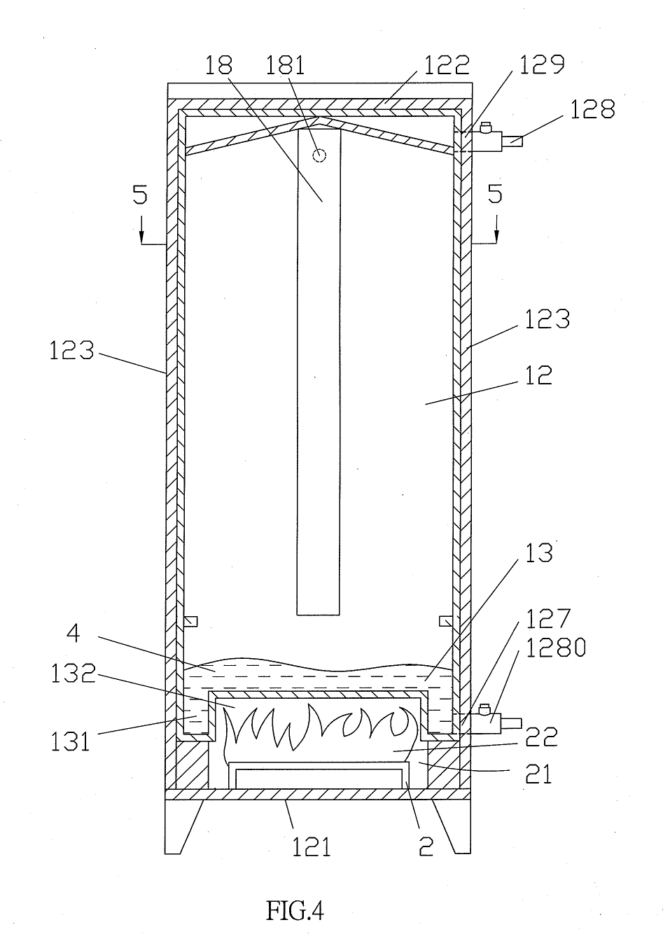

The bottom of the water tank 13 has a periphery provided with a downward extending water storage channel 131 connected to the water tank 13. The receiving recess 132 of the water tank 13 is encompassed by the water storage channel 131. The water storage channel 131 extends downward from the two sidewalls 123 and the front wall 125 of the case body 11 or from two opposite sides and a front side of the water tank 13 so that the water storage channel 131 has a substantially U-shaped profile as shown in FIGS. 4 and 5.

Thus, when the water 4 in the water tank 13 is heated by the burner 2, the flame 22 of the burner 2 is used to heat the water 4 in the water tank 13 and can also be used to heat the water 4 in the water storage channel 131 so that the heat produced by the burner 2 will not escape from the two sidewalls 123 or the front wall 125 of the case body 11 so as to enhance the heating area and efficiency of the steam case 1.

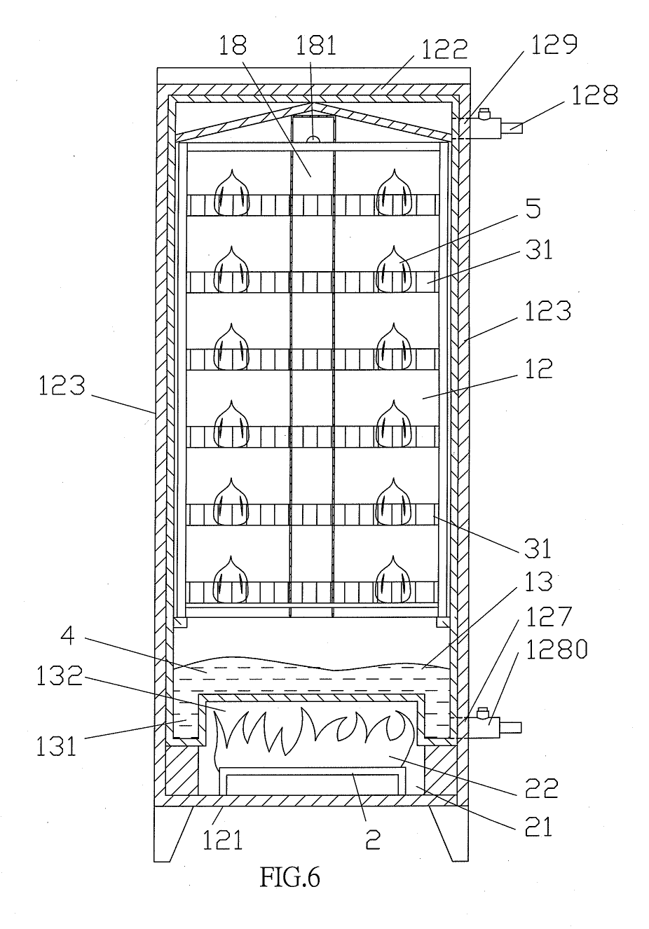

In operation, referring to FIG. 6 with reference to FIGS. 1-5, the water 4 in the water tank 13 and the water storage channel 131 of the case body 11 is heated and vaporized by the burner 2 to produce steams which rise and circulate in the receiving chamber 12 of the case body 11 so as to steam or braise foods 5 placed on the steam trays 31. At this time, the waste air produced by the burner 2 during the heating process passes through the air draining channel 14 of the case body 11 and is drained outwardly from the air draining port 141 of the air draining channel 14. At the same time, when the waste air produced by the burner 2 passes through the air draining channel 14 of the case body 11, the waste air at a higher temperature can be used to heat the water in the inner water storage conduit 15 and the outer water storage conduit 16 of the case body 11 so that the water in the inner water storage conduit 15 and the outer water storage conduit 16 of the case body 11 is disposed at a higher temperature. In such a manner, when the water level in the inner water storage conduit 15 of the case body 11 reaches the height of the overflow hole 181 of the passage 18, the hot water in the inner water storage conduit 15 and the outer water storage conduit 16 of the case body 11 is introduced through the overflow hole 181 and the passage 18 into the water tank 13 of the case body 11 to increase the temperature of the water 4 in the water tank 13 of the case body 11 so as to enhance the heating effect of the steam case 1.

Accordingly, the waste air produced by the burner 2 during the heating process is kept at a higher temperature and can be reused to heat the water in the inner water storage conduit 15 and the outer water storage conduit 16 and to increase the temperature of the water 4 in the water tank 13 of the case body 11 so as to shorten the heating time of the steam case. In addition, the waste air produced by the burner 2 during the heating process can be recycled and reused to provide a thermal energy to the steam case so as to save the energy resource. Further, the water storage channel 131 extends downward from the water tank 13 so that the heat produced by the burner 2 will not escape from the two sidewalls 123 or the front wall 125 of the case body 11 so as to enhance the heating area and efficiency of the steam case.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A steam case, comprising:
a case body having an inner portion provided with a hollow receiving chamber;
the receiving chamber of the case body having a bottom provided with a water tank connected to the receiving chamber;
the case body having a lower portion provided with a receiving space located under the water tank to receive a burner;
wherein the case body is provided with an inner water storage conduit and an outer water storage conduit;
wherein the case body is provided with an air draining channel located between the inner water storage conduit and the outer water storage conduit.

2. The steam case of claim 1, wherein the inner water storage conduit and the outer water storage conduit of the case body are located between the receiving chamber and a rear wall of the case body.

3. The steam case of claim 1, wherein
the water tank has a bottom provided with a receiving recess located above the burner;
the bottom of the water tank has a periphery provided with a downward extending water storage channel connected to the water tank.

4. The steam case of claim 3, wherein the receiving recess of the water tank is encompassed by the water storage channel.

5. The steam case of claim 3, wherein the water storage channel extends downward from two opposite sides and a front side of the water tank.

6. The steam case of claim 5, wherein the water storage channel has a substantially U-shaped profile.

7. The steam case of claim 3, wherein the water storage channel extends downward from two sidewalls and a front wall of the case body.

8. The steam case of claim 1, wherein the air draining channel of the case body has a top provided with an elongate air draining port exposed outwardly from a top wall of the case body.

9. The steam case of claim 3, wherein the air draining channel of the case body has a bottom connected to the receiving space.

10. The steam case of claim 9, wherein the bottom of the air draining channel of the case body is connected to the receiving recess of the water tank.

11. The steam case of claim 10, wherein the receiving recess of the water tank is connected to the receiving space of the case body to receive the burner.

12. The steam case of claim 3, wherein the receiving recess of the water tank is located above the receiving space of the case body to receive the burner.

13. The steam case of claim 1, wherein
the case body is provided with a water inlet hole;
the outer water storage conduit of the case body is connected to the water inlet hole of the case body;
the inner water storage conduit of the case body is connected to the outer water storage conduit.

14. The steam case of claim 13, wherein the inner water storage conduit and the outer water storage conduit of the case body form a loop to encompass the air draining channel completely.

15. The steam case of claim 1, wherein the case body is provided with a passage located and connected between the receiving chamber and the inner water storage conduit.

16. The steam case of claim 15, wherein
the passage of the case body has a bottom connected to the water tank;
the passage of the case body has a top provided with an overflow hole connected to a top of the inner water storage conduit.

17. The steam case of claim 1, wherein the guide ramp of the air draining channel faces the receiving recess of the water tank.

18. The steam case of claim 11, wherein the bottom of the air draining channel is provided with a guide ramp facing the burner and the receiving recess of the water tank.
